(19) United States
(12) Patent Application Publication
(10) Pub. No.: US 2025/0376776 A1
(43) Pub. Date: Dec. 11, 2025

(54) CORE-SHELL STRUCTURE FOR WATER ELECTROLYSIS, PREPARING METHOD OF THE SAME, AND THE ELECTRODE INCLUDING THE SAME

(71) Applicants: KOREA ELECTRIC POWER CORPORATION, Naju-si (KR); Research & Business Foundation SUNGKYUNKWAN UNIVERSITY, Suwon-si (KR)

(72) Inventors: Jung Kyu KIM, Suwon-si (KR); Won Tae HONG, Suwon-si (KR); Jong Hun KIM, Suwon-si (KR)

(21) Appl. No.: 19/195,651

(22) Filed: Apr. 30, 2025

(30) Foreign Application Priority Data
Apr. 30, 2024 (KR) 10-2024-0057603

(51) Int. Cl. C25B 11/091; C25B 11/052; C25B 11/067

(52) U.S. Cl. CPC C25B 11/091; C25B 11/052; C25B 11/067

(57) ABSTRACT

Embodiments of the present disclosure relate to a core-shell structure, a preparing method of the same, and an electrode including the same, and the core-shell structure may include a core comprising a perovskite nanocrystal; and a shell surrounding the core, thereby exhibiting improved optical, electrical, and catalytic properties and ensuring stable operating stability, thereby exhibiting excellent photoelectrochemical activity, compared to commercial catalysts such as conventional transition metal oxides.

### CROSS REFERENCE TO RELATED APPLICATION

This application claims priority to and the benefit of Korean Patent Application No. 10-2024-0057603, filed on Apr. 30, 2025, the disclosure of which is incorporated herein by reference in its entirety.

### BACKGROUND OF THE INVENTION

### Technical Field

Embodiments of the present disclosure relate to a core-shell structure, a preparing method of the same, and an electrode including the same, more particularly, to a core-shell structure with improved aqueous stability in which perovskite quantum dots with an oxide-based protective layer are introduced onto the surface of a transition metal oxide-based substrate, a preparing method of the same, and an electrode including the same.

### Background of the Disclosure

Fuel cells are attracting attention as a next-generation energy conversion technology because they have a very high power generation efficiency of 40-80%, produce little noise, and are environmentally friendly because the byproduct of the reaction is water. However, in order to commercialize them, it is necessary to efficiently supply the reactants, hydrogen and oxygen.

The conventional method of producing hydrogen by reforming fossil fuels has the problem that hydrogen is not infinite depending on the reserves of fossil fuels, and a method of producing hydrogen through water electrolysis is attracting attention as a way to solve this problem.

Electrochemical (EC) water electrolysis has attracted much attention because it can use power generated from renewable energy and has a compact design. In particular, photoelectrochemical (PEC) water electrolysis can effectively convert sustainable solar energy into chemical energy such as hydrogen through the photoelectric effect by using semiconductor materials as electrodes.

In particular, energy-efficient electrolytic cell operation is possible by inducing the electrolysis reaction at a lower redox potential than the conventional EC electrolysis reaction to achieve the same current density. However, the oxygen evolution reaction (OER), which is an oxidation reaction, is relatively slow as a four-electron reaction at 1.23 V compared to the standard hydrogen reduction potential compared to the two-electron reaction mechanism of the hydrogen evolution reaction (HER) electrode, and stable durability is required due to the high overvoltage, which limits the induction of effective PEC electrolysis reactions.

Among the photoelectrode materials used in the PEC electrolysis reaction, transition metal oxides are abundant in the earth's crust, so they can overcome the low economic of the previously used noble metal materials, and they also have an appropriate band gap and electronic band to induce the PEC electrolysis reaction.

However, there is a limit to effectively inducing the photoelectric effect due to the low light absorption coefficient of transition metal oxides, and there are issues in developing high-efficiency transition metal oxide-based photoelectrodes due to unexpected recombination of generated photocharges and low charge transfer characteristics at the photoelectrode/electrolyte interface.

Therefore, as an alternative, lead-halogen-based perovskite quantum dots (PQDs) have advantages such as excellent light absorption coefficient and bonding resistance, but they are difficult to apply as water electrolysis oxidation electrodes due to rapid recombination of photogenerated charges, self-oxidation by accumulation of photogenerated holes, and aqueous instability caused by ionic bonding characteristics.

### CITED DOCUMENTS

### Patent Document

(Cited patent document 1) Korean Patent Publication No. 10-2021-0151282 (Publication Date: Dec. 14, 2021)

### SUMMARY OF THE INVENTION

Accordingly, one object of the present disclosure is to solve the above-noted disadvantages of the prior art, and to provide a core-shell structure with improved aqueous stability in which perovskite quantum dots with an oxide-based protective layer are introduced onto the surface of a transition metal oxide-based substrate, a preparing method of the same, and an electrode including the same.

To solve the objects of the present disclosure, according to a first embodiment, a core-shell structure may include a core comprising a perovskite nanocrystal; and a shell surrounding the core;

The perovskite nanocrystal may be a core-shell structure including a compound represented by the following chemical formula 1.

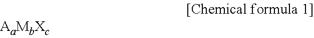

(In the chemical formula 1, A is a monovalent organic or inorganic cation, M is a divalent or trivalent metal cation, and X is a monovalent anion.)

The shell may include silica (SiO₂).

The shell may further include an inorganic semiconductor selected from the group consisting of TiOₓ (x is a real number from 1 to 3), indium oxide, tin oxide, zinc oxide, and zinc tin oxide.

The shell may be formed with a thickness of 0.5 nm or more and 2 nm or less.

To solve the objects, an electrode for electrolysis of water according to a second embodiment may include a support on which the core-shell structure according to the first embodiment is supported.

The support may include an inorganic semiconductor selected from a group consisting of tungsten oxide, titanium oxide, indium oxide, tin oxide, and zinc oxide.

To solve the object, a method of preparing a core-shell structure may include a first precursor solution preparation step of preparing a first precursor solution by dissolving a first precursor in an organic solvent; a first precursor solution preparation step of preparing a second precursor solution by dissolving a second precursor in an organic solvent; a core manufacturing step of preparing a core including perovskite nanocrystals by mixing the first precursor solution with the second precursor solution; and a shell formation step of forming a shell on the surface of the core by adding a shell precursor to the mixed solution including the core to form a core-shell structured catalyst nanoparticle.

The first precursor may include at least one selected from cesium carbonate (Cs₂CO₃), methylamidinium iodide (MAI), or formamidinium iodide (FAI).

The second precursor may include at least one selected from lead iodide (PbI₂), lead bromide (PbBr₂), lead chloride (PbCl₂), tin iodide (SnI₂), tin bromide (SnBr₂), or tin chloride (SnCl₂).

The shell precursor may be a silane compound.

According to the core-shell structure and the method of preparing the same, and the electrode including the same cording to the embodiment of the present disclosure, the use of nanoparticles, which are perovskite core-oxide shells, as a promoter may be more effective in securing operating stability in an aqueous system and increasing photoelectrochemical activity than conventional commercial catalysts such as transition metal oxides.

### BRIEF DESCRIPTION OF THE DRAWINGS

FIG. 1 is a cross-sectional view of a core-shell structure according to the present disclosure;

FIG. 2 is a flow chart showing the process of preparing a core-shell structure, which is a nanoparticle composed of a core and a shell, in sequence according to the method for manufacturing a core-shell structure according to the present disclosure;

FIG. 3 is a flow chart showing the process of preparing an electrode substrate on which a core-shell structure according to the present disclosure is supported;

FIG. 4 is a schematic diagram showing a process of preparing a core-shell structure nanoparticle in the form of a perovskite core-oxide shell according to the preparing method the core-shell structure according to the present disclosure;

FIG. 5a is a schematic diagram showing the process of preparing an electrode substrate on which a core-shell structure is supported according to the present disclosure.

FIG. 5b is a schematic diagram showing the process of preparing an electrode catalyst for water electrolysis on which a core-shell structure is supported, following the aforementioned process in FIG. 5a;

FIG. 6a is an image of a WO₃ substrate prepared according to steps S21 to S24 using a scanning electron microscope (SEM);

FIG. 6b is an image of a WO₃ substrate prepared according to steps S21 to S24 using a transmission electron microscope (TEM);

FIG. 7a is a view of transmission electron microscope (TEM) image showing CsPbBr₃(PQD)@SiO₂ perovskite quantum dots (Example) with a core-shell structure introduced with an ultra-thin SiO₂ shell at 10 nm scale;

FIG. 7b is a view of transmission electron microscope (TEM) image showing CsPbBr₃(PQD)@SiO₂ perovskite quantum dots (Example) with a core-shell structure introduced with an ultra-thin SiO₂ shell at 2 nm scale;

FIG. 7c is a view of transmission electron microscope (TEM) image showing CsPbBr₃(PQD) perovskite quantum dots (Comparative Example) without an SiO₂ shell introduced at 10 nm scale;

FIG. 7d is a view of transmission electron microscope (TEM) image showing CsPbBr₃(PQD) perovskite quantum dots (Comparative Example) without an SiO₂ shell introduced at 2 nm scale;

FIG. 8a is a view showing an image of a sample analyzed by high angle annular dark field-scanning transmission electron microscopy (HAADF-STEM) to confirm that the shell of a perovskite quantum dot (example), which is a core-gum structure (amorphous SiO₂);

FIG. 8b is a view showing an image of a sample analyzed by spectrum analyzed by X-ray photoelectron spectroscopy;

FIG. 8c is a view showing a spectrum of a sample analyzed by Fourier transform infrared spectroscopy (FTIR);

FIG. 9a is a view showing the catalyst electrode (PQD@SiO₂/WO₃) manufactured according to an example, as observed through a scanning electron microscope (SEM);

FIG. 9b is a view showing the catalyst electrode (PQD@SiO₂/WO₃) manufactured according to an example, as observed through a transmission electron microscope (TEM) at 10 nm scale;

FIG. 9c is a view showing the catalyst electrode (PQD@SiO₂/WO₃) manufactured according to an example, as observed through a transmission electron microscope (TEM) at 2 nm scale with marks of CsPbBr₃ and WO₃;

FIG. 10a is a diagram showing the results of analyzing the single quantum dot (PQD@SiO₂) prepared according to an example using X-ray diffraction (XRD) compared to a perovskite quantum dot (PQD) with a reference of CsPbBr₃ (JCPDS #54-0752);

FIG. 10b is a diagram showing the results of analyzing the catalyst electrode (PQD@SiO₂/WO₃) prepared according to an example using X-ray diffraction (XRD) compared to a WO₃ support with a reference of WO₃ (JCPDS #543-1035) and WO_{2.9} (JCPDS #05-0386);

FIG. 11 is a diagram showing the results of UV-Visible spectroscopy (red: Example, black: Comparative Example) performed to observe changes in the optical properties of perovskite quantum dots (Example-PQD@SiO₂, Comparative Example-PQD) with or without a SiO₂ shell;

FIG. 12a is a diagram showing W 4f spectra of X-ray photoelectron spectroscopy analysis showing the changes in surface chemical bonding in the catalyst electrode (PQD@SiO₂/WO₃) and the core-shell structure (PQD@SiO₂), the support (WO₃) according to the example;

FIG. 12b is a diagram showing O 1s spectra of X-ray photoelectron spectroscopy analysis showing the changes in surface chemical bonding in the catalyst electrode (PQD@SiO₂/WO₃) and the core-shell structure (PQD@SiO₂), the support (WO₃) according to the example;

FIG. 12c is a diagram showing Pb 4f spectra of X-ray photoelectron spectroscopy analysis showing the changes in surface chemical bonding in the catalyst electrode (PQD@SiO₂/WO₃) and the core-shell structure (PQD@SiO₂), reference electrode (PQD/WO₃), single quantum dot (PQD) according to the example;

FIG. 12d is a diagram showing Br 3d spectra of X-ray photoelectron spectroscopy analysis showing the changes in surface chemical bonding in the catalyst electrode (PQD@SiO₂/WO₃) and the core-shell structure (PQD@SiO₂), reference electrode (PQD/WO₃), single quantum dot (PQD) according to the example;

FIG. 12e is a diagram showing Cs 3d spectra of X-ray photoelectron spectroscopy analysis showing the changes in surface chemical bonding in the catalyst electrode (PQD@SiO₂/WO₃) and the core-shell structure (PQD@SiO₂) according to the example;

FIG. 12f is a diagram showing Cs 3d spectra of X-ray photoelectron spectroscopy analysis showing the changes in surface chemical bonding in the reference electrode (PQD/WO₃), single quantum dot (PQD) according to the example;

FIG. 13a is a diagram showing the current density under light irradiation conditions of a three-electrode system configured with a catalyst electrode (PQD@SiO₂/WO₃) according to an embodiment, a comparative electrode (PQD/WO₃) according to a comparative example, and an electrode formed only with a support (WO₃) as a working electrode;

FIG. 13b is a diagram showing the current density under dark conditions (in the absence of light irradiation) of a three-electrode system configured with a catalyst electrode (PQD@SiO₂/WO₃) according to an embodiment, a comparative electrode (PQD/WO₃) according to a comparative example, and an electrode formed only with a support (WO₃) as a working electrode;

FIG. 13c is a diagram showing the photon conversion efficiency (IPCE) of a three-electrode system configured with a catalyst electrode (PQD@SiO₂/WO₃) according to an embodiment, a comparative electrode (PQD/WO₃) according to a comparative example, and an electrode formed only with a support (WO₃) as a working electrode;

FIG. 14a is a view showing the absorbance of the catalyst electrode according to an embodiment (PQD@SiO₂/WO₃) and a comparative electrode (PQD/WO₃) and a support (WO₃) according to a comparative example;

FIG. 14b is a view showing the charge transfer efficiency of a three-electrode system formed by these as a working electrode according to an embodiment (PQD@SiO₂/WO₃) and a comparative electrode (PQD/WO₃) and a support (WO₃) according to a comparative example;

FIG. 14c is a view showing the charge transport efficiency of a three-electrode system formed by these as a working electrode according to an embodiment (PQD@SiO₂/WO₃) and a comparative electrode (PQD/WO₃) and a support (WO₃) according to a comparative example;

FIG. 15a is a view showing the applied bias photon-to-current efficiency (ABPE) by configuring a three-electrode system with a catalyst electrode (PQD@SiO₂/WO₃) according to an embodiment, a comparative electrode (PQD/WO₃) according to a comparative example, and an electrode formed only with a support (WO₃) as a working electrode;

FIG. 15b is a view showing the change in photocurrent density over time by configuring a three-electrode system with a catalyst electrode (PQD@SiO₂/WO₃) according to an embodiment, a comparative electrode (PQD/WO₃) according to a comparative example, and an electrode formed only with a support (WO₃) as a working electrode;

FIG. 16 is a view showing the change in current density when the same measurement as FIG. 13 was performed according to the loading concentration of the core-shell structure (PQD@SiO₂) to manufacture a catalyst electrode (PQD@SiO₂/WO₃) according to an embodiment;

FIG. 17 shows the results of performing a water electrolysis reaction on a catalyst electrode (PQD@SiO₂/WO₃) manufactured according to an example using a transmission electron microscope (TEM) as shown in FIG. 9b;

FIG. 18a is a view showing the results of analyzing the surface chemical bonding changes by element using X-ray photoelectron spectroscopy before and after performing a photoelectrochemical water electrolysis reaction on a three-electrode like FIGS. 12a to 12f of a catalyst electrode (PQD@SiO₂/WO₃) manufactured according to an example;

FIG. 18b is W 4f X-ray photoelectron spectra showing the surface chemical bonding changes before and after performing a photoelectrochemical water electrolysis reaction on a three-electrode like FIGS. 12a to 12f of a catalyst electrode (PQD@SiO₂/WO₃) manufactured according to an example;

FIG. 18c is O 1s X-ray photoelectron spectra showing the surface chemical bonding changes before and after performing a photoelectrochemical water electrolysis reaction on a three-electrode like FIGS. 12a to 12f of a catalyst electrode (PQD@SiO₂/WO₃) manufactured according to an example;

FIG. 19a is Cs 3d X-ray photoelectron spectra showing the surface chemical bonding changes before and after performing a photoelectrochemical water electrolysis reaction on a three-electrode like FIGS. 12a to 12f of a catalyst electrode (PQD@SiO₂/WO₃) manufactured according to an example;

FIG. 19b is Pb 4f X-ray photoelectron spectra showing the surface chemical bonding changes before and after performing a photoelectrochemical water electrolysis reaction on a three-electrode like FIGS. 12a to 12f of a catalyst electrode (PQD@SiO₂/WO₃) manufactured according to an example;

FIG. 19c is Br 3d X-ray photoelectron spectra showing the surface chemical bonding changes before and after performing a photoelectrochemical water electrolysis reaction on a three-electrode like FIGS. 12a to 12f of a catalyst electrode (PQD@SiO₂/WO₃) manufactured according to an example;

FIG. 20a is a view showing an analysis of charge behavior during photoelectrochemical water electrolysis by using electrochemical impedance spectroscopy (EIS) to configure a three-electrode system using a catalyst electrode (PQD@SiO₂/WO₃) according to an embodiment, a comparative electrode (PQD/WO₃) according to a comparative example, and an electrode formed only with a support (WO₃) as a working electrode;

FIG. 20b is a graph with log frequency on the X-axis and the phase-shift on the Y-axis by using electrochemical impedance spectroscopy (EIS) to configure a three-electrode system using a catalyst electrode (PQD@SiO₂/WO₃) according to an embodiment, a comparative electrode (PQD/WO₃) according to a comparative example, and an electrode formed only with a support (WO₃) as a working electrode;

FIG. 20c is a view showing a Mott-Schottky analysis to configure a three-electrode system using a catalyst electrode (PQD@SiO₂/WO₃) according to an embodiment, a comparative electrode (PQD/WO₃) according to a comparative example, and an electrode formed only with a support (WO₃) as a working electrode;

FIG. 21 is a view comparing the open circuit voltage (OCV) when irradiating light by configuring a three-electrode system with a catalyst electrode (PQD@SiO₂/WO₃) according to an embodiment and a comparative electrode (PQD/WO₃) according to a comparative example and an electrode formed only with a support (WO₃) as a working electrode;

FIG. 22a is a photograph of the two-electrode water electrolysis system using a catalyst electrode (PQD@SiO₂/WO₃) according to an embodiment as a working electrode, and using a counter electrode and a proton exchange membrane.

FIG. 22b shows the results of the actual hydrogen production amount after 3 h evolution by configuring a two-electrode water electrolysis system using a catalyst electrode (PQD@SiO₂/WO₃) according to an embodiment, a comparative electrode (PQD/WO₃) according to a comparative example, and an electrode formed only with a support (WO₃) as a working electrode, and using a counter electrode and a proton exchange membrane.

FIG. 22c shows the results of analyzing the production efficiency (Faraday efficiency) after 3 h evolution by configuring a two-electrode water electrolysis system using a catalyst electrode (PQD@SiO₂/WO₃) according to an embodiment, a comparative electrode (PQD/WO₃) according to a comparative example, and an electrode formed only with a support (WO₃) as a working electrode, and using a counter electrode and a proton exchange membrane.

### DESCRIPTION OF SPECIFIC EMBODIMENTS

Description will now be given in detail according to exemplary embodiments disclosed herein, with reference to the accompanying drawings.

For the sake of brief description with reference to the drawings, the same or equivalent components may be provided with the same reference numbers, and description thereof will not be repeated.

These terms are generally only used to distinguish one element from another. It will be understood that the terms “first” and “second” are used herein to describe various components but these components should not be limited by these terms. The above terms are used only to distinguish one component from another. For example, a first component may be referred to as a second component and vice versa without departing from the scope of the invention. The singular expressions include plural expressions unless the context clearly dictates otherwise.

The term “and/or” may include any combination of multiple related listed items or any one of multiple related listed items.

It will be understood that when an element is referred to as being “connected with”, “on” or “coupled to” another element, the element can be directly connected with the other element or intervening elements may also be present. In contrast, when an element is referred to as being “directly connected with” another element, there are no intervening elements present.

Throughout the disclosure, each component can be provided as a single one or a plurality of ones, unless explicitly stated to the contrary.

Terms such as “comprise” or “comprising” are used herein and should be understood that they are intended to indicate an existence of several components, functions, or steps, disclosed in the specification, and it is also understood that greater or fewer components, functions, or steps may likewise be utilized. However, the present disclosure may be embodied in various modified examples, and is not limited to embodiments described herein.

Terminology that is used in the present disclosure is limited to only for embodiments herewith but made only to make it easy to understand the present disclosure. Terms of respective elements used in the following description are terms defined taking into consideration of the functions obtained in the present invention. Therefore, these terms do not limit technical elements in the present invention. Further, the defined terms of the respective elements will be called other terms in the art.

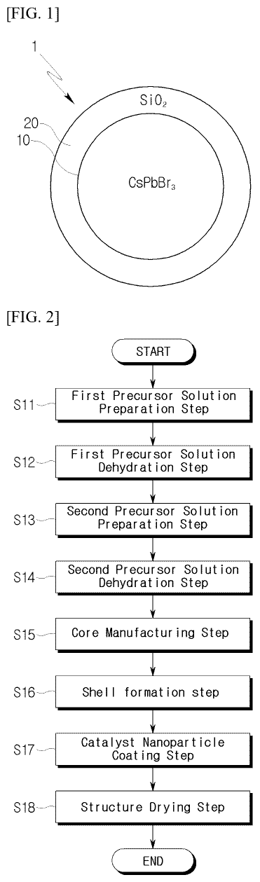

FIG. 1 is a block view showing an imaging system according to one embodiment.

Referring to FIG. 1, the core-shell structure according to a first embodiment may include a core 10 including perovskite nanocrystals and a shell 20 surrounding the core 10.

The perovskite nanocrystal includes a compound represented by the following chemical formula 1.

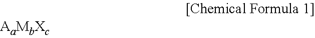

In the chemical formula 1, A is a monovalent organic or inorganic cation, M is a divalent or trivalent metal cation, and X is a monovalent anion.

For example, A may be a metal ion such as cesium (Cs⁺), rubidium (Rb⁺), or francium (Fr⁺), or an organic ion such as methylamidinium (MA⁺) or formamidinium (FA⁺), but is not limited thereto, and any organic or inorganic ion may be used without limitation as long as a three-dimensional perovskite is formed.

M can be a divalent metal ion such as lead (Pb²⁺), tin (Sn²⁺), or manganese (Mn²⁺), or a trivalent metal ion such as bismuth (Bi³⁺) or antimony (Sb³⁺), but the present disclosure is not limited thereto, and can be used without limitation on condition that a three-dimensional perovskite is formed.

X is a halogen element, and chlorine (Cl⁻), bromine (Br⁻), or iodine (I⁻) can be used, but is not limited thereto, and can be used without limitation if a three-dimensional perovskite is formed.

The shell 20 can use an inorganic oxide such as silica (SiO₂), alumina (Al₂O₃), a carbon-based material such as C₃N₄, or a polymer such as polyvinylidene fluoride (PVDF), and most preferably, silica that is easy to control the ligand and has appropriate dielectric properties is used.

The shell 20 may further include an inorganic semiconductor selected from the group consisting of TiOₓ (x is a real number from 1 to 3), indium oxide, tin oxide, zinc oxide, and zinc tin oxide.

The above shell 20 can be formed with a thickness of 0.5 nm or more and 2 nm or less.

If the thickness of the above shell 20 is coated to be less than 0.5 nm, many defects occur in which the core 10 is not protected from the aqueous environment, resulting in a problem of reduced long-term stability.

In addition, when the thickness of the above shell 20 is coated to be more than 2 nm, the additional effect of protecting the core 10 from the aqueous environment is minimal, and the problem occurs that the resistance increases due to the charge transfer being hindered by the insulator.

In addition, the water electrolysis electrode according to a second embodiment is formed by supporting the core-shell structure 1 according to the first embodiment of the present invention on the support 2.

The support 2 may include an inorganic semiconductor selected from at least one metal oxide group consisting of tungsten oxide, titanium oxide, iron oxide, indium oxide, tin oxide, and zinc oxide, and provides a sufficient surface area so that the nanoparticle 1 composed of the core 10 and the shell 20 can be supported on the surface.

It is preferable to use tungsten oxide, which has a similar energy level to the perovskite nanocrystal, as the support 2.

In addition, the method of preparing a core-shell structure according to a third embodiment, as shown in FIG. 2, may include a first precursor solution preparation step (S11) of preparing a first precursor solution by dissolving a first precursor in an organic solvent, a second precursor solution preparation step (S13) of preparing a second precursor solution by dissolving a second precursor in an organic solvent, a core preparation step (S15) of preparing the core 10 including a perovskite nanocrystal by mixing the first precursor solution with the second precursor solution, and a shell formation step (S16) of forming the shell 20 on the surface of the core 10 by adding a shell precursor to the mixed solution including the core 10, thereby forming the nanoparticle 1 having a core-shell structure.

The first precursor may include at least one selected from a group of compounds capable of providing a monovalent organic or inorganic cation, such as cesium carbonate (Cs₂CO₃), methylamidinium iodide (MAI), or formamidinium iodide (FAI).

The second precursor may include at least one selected from a group of compounds capable of providing a divalent or trivalent inorganic cation, such as lead iodide (PbI₂), lead bromide (PbBr₂), lead chloride (PbCl₂), tin iodide (SnI₂), tin bromide (SnBr₂), or tin chloride (SnCl₂).

The shell precursor is a silane compound.

3-(aminopropyl) triethoxysilane [APTES] and (3-glycidyloxypropyl) trimethoxy silane [GPTMS] are used as the silane compound.

In the first precursor solution preparation step (S11) and the second precursor solution preparation step (S13), a chain hydrocarbon such as 1-Octadecene or a branched hydrocarbon can be used as an organic solvent.

In the first precursor solution preparation step (S11) or the second precursor solution preparation step (S13), a ligand such as oleic acid and oleylamine may be used in the first precursor solution or the second precursor solution to disperse the core 10 including perovskite nanocrystals.

After the first precursor solution preparation step (S11) is performed, the first precursor solution may be heated at a temperature of 100° C. or more and 140° C. or less for a time of 30 minutes or more and 60 minutes or less to remove moisture in the mixed solution, and the first precursor solution dehydration step (S12) may be performed.

In addition, after the second precursor solution preparation step (S13) is performed, the second precursor solution may be heated at a temperature of 100° C. or more and 150° C. or less for a time of 30 minutes or more and 60 minutes or less to remove moisture in the mixed solution, and the second precursor solution dehydration step (S14) may be performed.

After that, the first precursor solution is heated to 140° C. or higher and 160° C. or lower, the second precursor solution is heated to 160° C. or higher and 180° C. or lower, and the first precursor solution and the second precursor solution are mixed to perform the core manufacturing step (S15).

After that, in the shell forming step (S16), the shell precursor is added to the solution in which the core 10 obtained in the core manufacturing step (S15) is dispersed, so that the shell 20 is formed on the outer surface of the core 10, thereby forming the nanoparticle 1 having a core-shell structure.

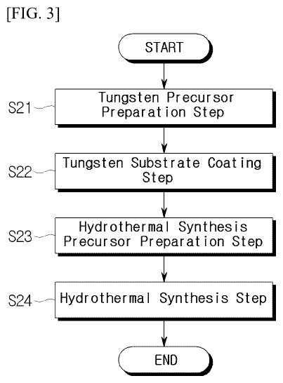

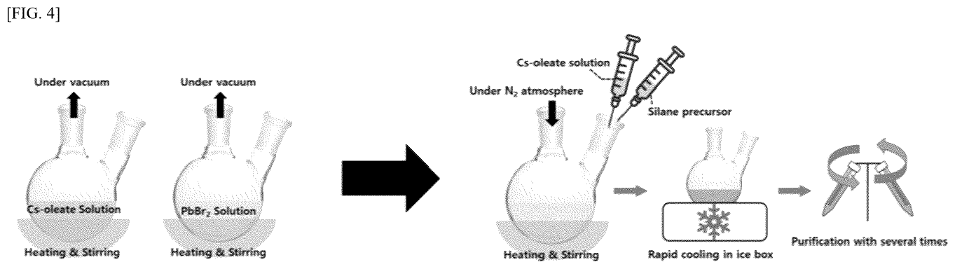

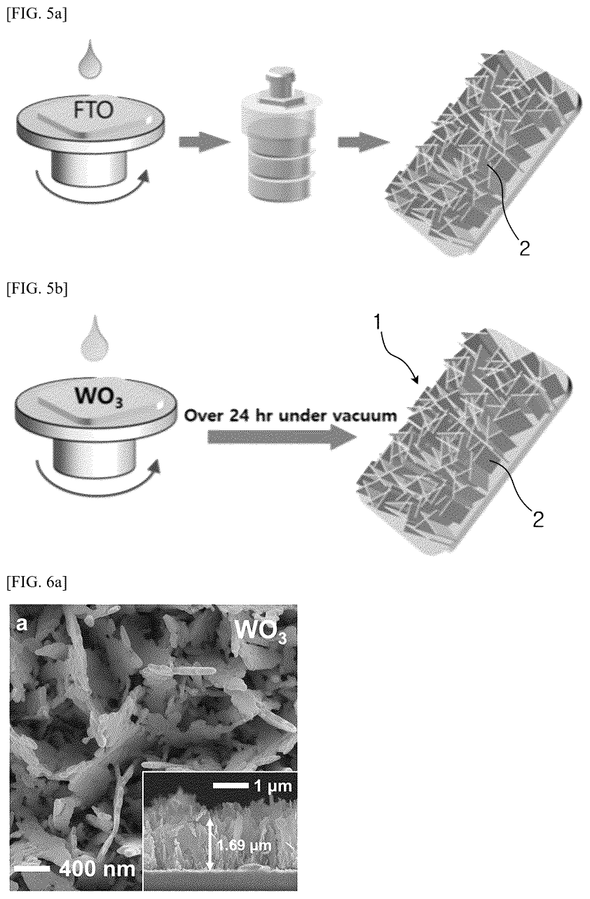

In addition, referring to FIG. 3, the method for preparing the core-shell structure according to the second embodiment may further include a method of preparing a transition metal oxide-based support 2 substrate (S21 to S24) before the nanoparticle coating step (S17) is performed, and although it is expressed separately in FIG. 3 for convenience in understanding the invention implemented by integrating it into the order of FIG. 2.

In addition, referring to FIG. 2, the method for manufacturing a core-shell structure according to the second embodiment of the present invention further includes a catalyst nanoparticle coating step (S17) of dispersing the nanoparticle 1 (=the core-shell structure) in an organic solvent and then coating it on a substrate on which the support 2 is formed to manufacture a catalyst electrode.

The organic solvent used in the nanoparticle coating step (S17) may be hexane (n-hexane), but the present disclosure is not limited thereto.

The solution in which the core-shell structure nanoparticles 1 are dispersed is dropped in a predetermined amount on the substrate on which the support 2 is formed, and then rotated at 2000 rpm for 30 seconds so that the nanoparticles 1 are uniformly supported on the support 2.

In addition, the method for preparing the water electrolysis electrode according to the second embodiment may further include a structure drying step (S18) in which, after the nanoparticle coating step (S17) is performed, the support 2 on which the nanoparticles 1 are supported is vacuum-dried for 12 hours or more and 24 hours or less to prepare the final core-shell structure.

Referring to FIG. 3, the steps (S21 to S24) for manufacturing the substrate on which the support 2 is formed are exemplarily explained as follows.

First, a tungsten precursor preparation step (S21) is performed in which 0.375 g of H₂WO₄ and 3 mL of hydrogen peroxide are stirred at 140° C. for 3 hours, and then 9 mL of deionized water and 0.15 g of PVA (polyvinylalcohol) are added and stirred at 70° C. for 25 minutes to prepare a tungsten precursor solution.

After that, a tungsten substrate coating step (S22) is performed in which the tungsten precursor solution is spin-coated on a glass substrate coated with FTO (F-doped SnO₂), and then heat-treated in an electric furnace at 500° C. for 2 hours to prepare a tungsten precursor substrate.

In addition, a hydrothermal synthesis precursor preparation step (S23) is performed in which 14.84 mL of acetonitrile, 0.59 mL of 6M HCl, 0.059 g of urea, and 0.024 g of oxalic acid are injected into 3.56 mL of a solution prepared by stirring 0.179 g of H₂WO₄, 2.46 mL of hydrogen peroxide, and 3.57 mL of deionized water at 100° C. for 15 minutes, and then stirred for 10 minutes to prepare a hydrothermal synthesis precursor solution.

After that, the tungsten precursor substrate prepared in the tungsten substrate coating step (S22) is immersed in the hydrothermal synthesis precursor solution, and then reacted in an autoclave reactor at 180° C. for 2 hours and heat-treated in an electric furnace at 500° C. for 2 hours to prepare a substrate on which a tungsten oxide support is formed, a hydrothermal synthesis step (S24) is performed.

However, the present disclosure is not limited to the above steps, and any method for manufacturing a substrate on which an oxide support is formed can be applied by a general technician.

### Experimental Example

Below, the results of the property evaluation comparison between the electrolytic electrode catalyst (Example) manufactured by applying the method for manufacturing the electrolytic electrode catalyst according to the present invention and the electrolytic electrode catalyst (Comparative Example) manufactured by the prior art will be explained.

### (1) Example

First, in order to manufacture a substrate having a tungsten oxide (WO₃) support formed, a tungsten precursor preparation step (S21) was performed in which 0.375 g of H₂WO₄ and 3 mL of hydrogen peroxide were stirred at 140° C. for 3 hours, and then 9 mL of deionized water and 0.15 g of PVA (polyvinyl alcohol) were added and stirred at 70° C. for 25 minutes to prepare a tungsten precursor solution.

After that, the tungsten precursor solution was spin-coated on a glass substrate coated with FTO (F-doped SnO₂), and then heat-treated in an electric furnace at 500° C. for 2 hours to prepare a tungsten precursor substrate, in which a tungsten substrate coating step (S22) was performed.

In addition, a hydrothermal synthesis precursor preparation step (S23) was performed to prepare a hydrothermal synthesis precursor solution by injecting 14.84 mL of acetonitrile, 0.59 mL of 6M HCl, 0.059 g of urea, and 0.024 g of oxalic acid into 3.56 mL of a solution prepared by stirring 0.179 g of H₂WO₄, 2.46 mL of hydrogen peroxide, and 3.57 mL of deionized water at 100° C. for 15 minutes and stirring for 10 minutes.

After that, a hydrothermal synthesis step (S24) was performed in which the tungsten precursor substrate prepared in the tungsten substrate coating step was immersed in the hydrothermal synthesis precursor solution, reacted in an autoclave reactor at 180° C. for 2 hours, and heat-treated in an electric furnace at 500° C. for 2 hours to manufacture a substrate on which a tungsten oxide support was formed.

Hence, the core-gum structure 1 including a core 10 containing perovskite (CsPbBr₃) nanocrystals and a SiO₂ shell 20 surrounding the core is prepared as follows.

A first precursor solution preparation step (S11) is performed in which 0.2 g of Cs₂CO₃ as a first precursor, 8 mL of 1-octadecene as an organic solvent, 0.7 mL of oleic acid as a fatty acid, and 0.5 mL of oleylamine as a dispersant are stirred in a reactor to prepare a first precursor solution.

After that, the first precursor solution is heated at 130° C. under vacuum conditions for 30 minutes, and a first precursor solution dehydration step (S12) is performed to remove moisture in the first precursor solution.

In addition, a second precursor solution preparation step (S13) is performed to prepare a second precursor solution by stirring a mixed solution of 0.415 g of PbBr₂ as a second precursor, 18 mL of 1-octadecene as an organic solvent, 3 mL of oleic acid as a fatty acid, and 1.5 mL of oleylamine as a dispersant in a reactor.

After that, the first precursor solution dehydration step (S14) is performed to remove moisture in the second precursor solution by heating the second precursor solution at 100° C. under vacuum conditions for 30 minutes.

Then, the first precursor solution is heated to 150° C., the second precursor solution is heated to 170° C., and the first precursor solution and the second precursor solution are mixed to form a core including CsPbBr₃ perovskite nanocrystals, in a core preparing step (S15).

After that, 2.5 mL of APTES (3-(aminopropyl)triethoxysilane) and GPTMS ((3-Glycidyloxypropyl)trimethoxy silane) as shell precursors are added to the mixed solution including the core, and a shell forming step (S16) is performed to form a shell of a 1 nm-level SiO₂ ultra-thin film on the surface of the core, thereby forming a core-shell structured nanoparticle.

Additionally, the core-shell structure nanoparticles were extracted from the organic solvent used during synthesis through centrifugation using methyl acetate and acetone.

In addition, the core-shell structure nanoparticles 1 were dispersed in a hexane solution, dropped in a predetermined amount on a substrate on which a tungsten oxide support 2 was formed, and then rotated at 2000 rpm for 30 seconds to perform a nanoparticle coating step (S17) in which the nanoparticles 1 are uniformly supported on the support 2.

After that, the catalyst drying step (S18) was performed to manufacture the final catalyst electrode by vacuum drying the support 2 on which the nanoparticles 1 were supported for 12 hours.

### (2) Comparative Example

As a comparative example, in comparison with the example, the same steps as in the example were performed except for the shell formation step (S16) to manufacture the catalyst nanoparticles (Comparative Example 1), and a detailed description is omitted.

In addition, a comparative electrode (Comparative Example 2) was manufactured by performing a nanoparticle coating step (S17) and a catalyst drying step (S18).

### 2. Property Evaluation

Hereinafter, the core PQD/shell SiO₂ nanoparticles including CsPbBr₃ perovskite nanocrystals, which are electrolytic electrode catalysts manufactured by applying the method for manufacturing an electrolytic electrode catalyst according to the present invention, and the core PQD nanoparticles including perovskite nanocrystals as a comparative example and WO₃ used as a support, will be described to compare the property evaluation results between the examples and comparative examples.

### Electron Microscope

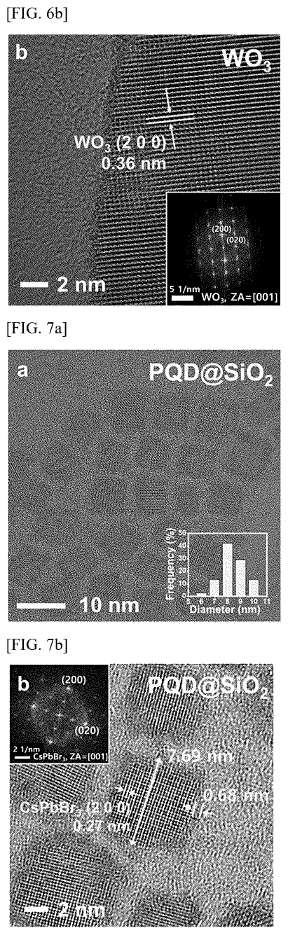

FIGS. 6a to 6b are images of a WO₃ substrate prepared according to steps S21 to S24 using a scanning electron microscope (SEM) and a transmission electron microscope (TEM).

Referring to FIG. 6a, the two-dimensional WO₃ structure shows a nanoflake-shaped shape and has a thickness of about 1.7 μm when observed from the side.

Referring to FIG. 6b, the crystallographic structure of the WO₃ substrate has a crystal plane distance of 0.36 nm corresponding to the (200) crystal plane of WO₃ having a monoclinic system, and the (200) plane and the (020) plane were confirmed in the selected area electron diffraction (SAED) pattern.

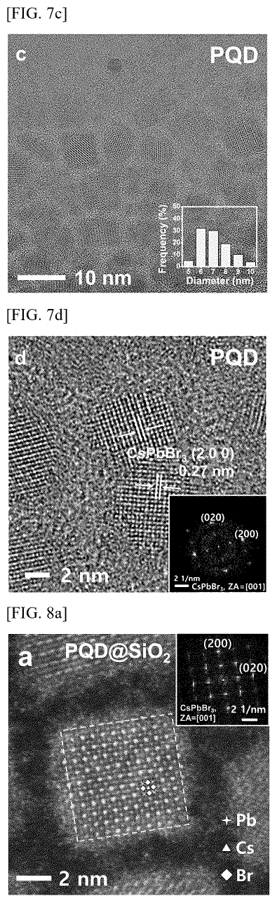

FIGS. 7a to 7b are views of transmission electron microscope (TEM) image showing CsPbBr₃(PQD) @SiO₂ perovskite quantum dots (Example) with a core-shell structure introduced with an ultra-thin SiO₂ shell at each 10 nm and 2 nm scale.

FIGS. 7c to 7d are views of transmission electron microscope (TEM) image showing CsPbBr₃(PQD) perovskite quantum dots (Comparative Example) with a core-shell structure introduced with an ultra-thin SiO₂ shell at each 10 nm and 2 nm scale.

In the case of Example 1 having a core-shell structure, it exhibits a nanocube-shaped shape and an average diameter of about 8.4 nm, and in the case of Comparative Example 1, it exhibits a shape that is relatively close to a spherical shape and an average diameter of about 7.5 nm.

Both samples showed a crystal plane distance of 0.27 nm corresponding to the (200) plane of cubic CsPbBr₃, and the (200) and (020) crystal planes were confirmed in the SAED pattern.

Notably, in the case of Example 1, an amorphous SiO₂ shell of about 0.7 nm was observed to homogeneously surround the outer surface of the CsPbBr₃ core.

### Component Verification

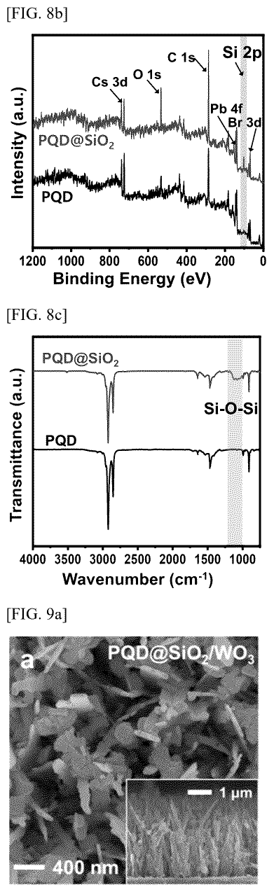

FIG. 8a is a view showing an image of a sample analyzed by high angle annular dark field-scanning transmission electron microscopy (HAADF-STEM) to confirm that the shell of a perovskite quantum dot (example), which is a core-gum structure (amorphous SiO₂).

FIG. 8b is a view showing an image of a sample analyzed by spectrum analyzed by X-ray photoelectron spectroscopy, and FIG. 8c is a view showing a spectrum of a sample analyzed by Fourier transform infrared spectroscopy (FTIR).

In FIG. 8a, the crystal of the CsPbBr₃ nucleus of the perovskite quantum dot structure with SiO₂ shell as confirmed through the atomic level image and atomic size distribution.

At this time, the chemical composition of the amorphous shell existing on the outer surface of the perovskite core was confirmed through XPS and FTIR, respectively, by confirming the Si 2p signal and Si—O—Si vibration originating from the SiO₂ shell, and confirming that the amorphous shell was made of SiO₂ through FIG. 8b and FIG. 8c.

### Analysis of the Shape of the Electrode Catalyst for Water Electrolysis

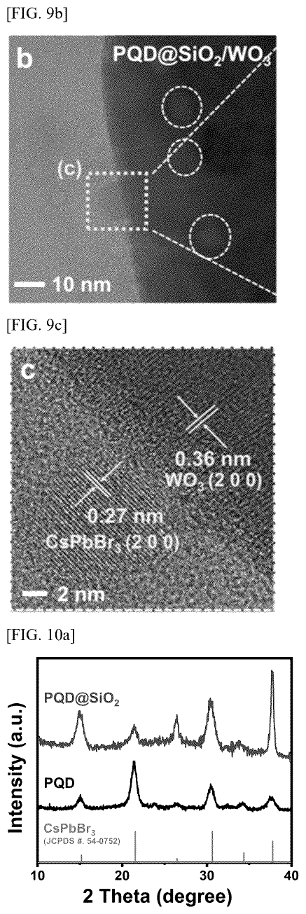

FIGS. 9a to 9b are views showing the catalyst electrode (PQD@SiO₂/WO₃) manufactured according to an example, as observed through a scanning electron microscope (SEM) and a transmission electron microscope (TEM) at 10 nm scale.

FIG. 9c is a view showing the catalyst electrode (PQD@SiO₂/WO₃) manufactured according to an example, as observed through a transmission electron microscope (TEM) at 2 nm scale with marks of CsPbBr₃ and WO₃.

After quantum dots (PQD@SiO₂) were introduced to the WO₃ electrode, it was observed that they were formed in a hybrid form without any morphological or crystallographic changes in the quantum dots and WO₃ substrate, respectively.

### XRD Analysis of Nanoparticles and Electrode Catalysts

FIG. 10a is a diagram showing the results of analyzing the single quantum dot (PQD@SiO₂) prepared according to an example using X-ray diffraction (XRD) compared to a perovskite quantum dot (PQD) with a reference of CsPbBr₃ (JCPDS #54-0752).

FIG. 10b is a diagram showing the results of analyzing the catalyst electrode (PQD@SiO₂/WO₃) prepared according to an example using X-ray diffraction (XRD) compared to a WO₃ support with a reference of WO₃ (JCPDS #543-1035) and WO_{2.9} (JCPDS #05-0386).

As in FIGS. 10a to 10b, it can be confirmed through comparison with the JCPDS reference peak (CsPbBr₃, WO₃) that no crystallographic change of the WO₃ substrate occurred after quantum dots (PQD@SiO₂) were introduced onto the WO₃ electrode.

### Changes in Optical Properties According to SiO₂ Shell

FIG. 11 is a diagram showing the results of UV-Visible spectroscopy (red: Example, black: Comparative Example) performed to observe changes in the optical properties of perovskite quantum dots (Example-PQD@SiO₂, Comparative Example-PQD) with or without a SiO₂ shell.

The band gaps confirmed by UV-visible spectroscopy were 2.45 and 2.41 eV before and after the introduction of SiO₂, respectively, confirming similar optical properties.

### Confirmation of Chemical Bonding on the Surface

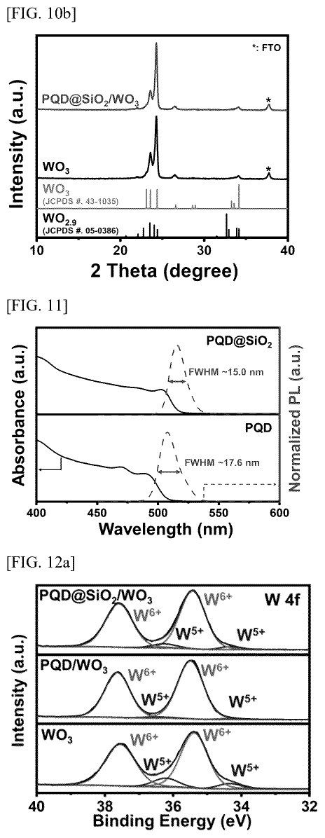

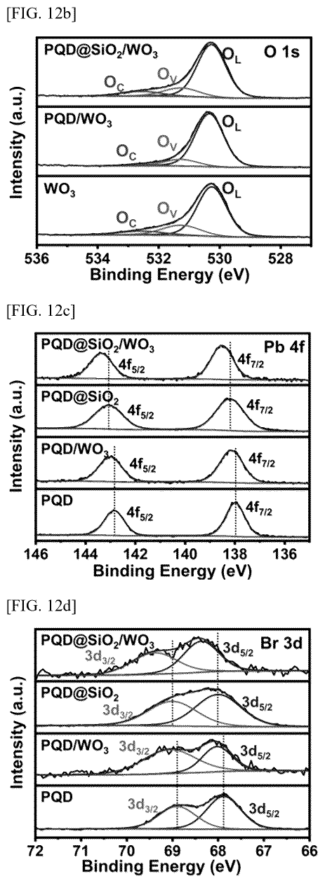

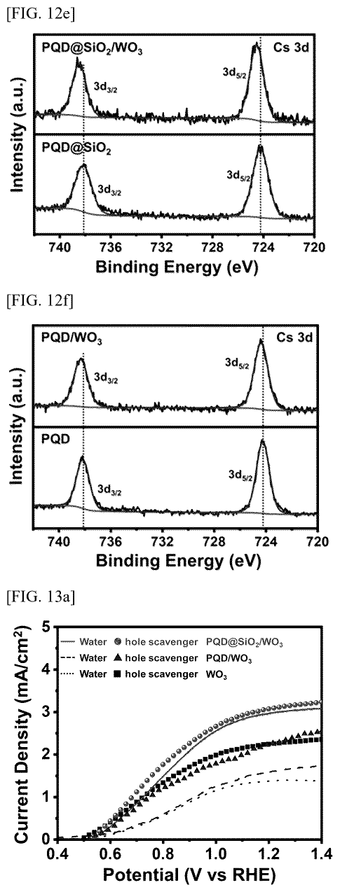

FIG. 12a is a diagram showing W 4f spectra of X-ray photoelectron spectroscopy analysis showing the changes in surface chemical bonding in the catalyst electrode (PQD@SiO₂/WO₃) and the core-shell structure (PQD@SiO₂), the support (WO₃) according to the example.

FIG. 12b is a diagram showing O 1s spectra of X-ray photoelectron spectroscopy analysis showing the changes in surface chemical bonding in the catalyst electrode (PQD@SiO₂/WO₃) and the core-shell structure (PQD@SiO₂), the support (WO₃) according to the example.

FIG. 12c is a diagram showing Pb 4f spectra of X-ray photoelectron spectroscopy analysis showing the changes in surface chemical bonding in the catalyst electrode (PQD@SiO₂/WO₃) and the core-shell structure (PQD@SiO₂), reference electrode (PQD/WO₃), single quantum dot (PQD) according to the example.

FIG. 12d is a diagram showing Br 3d spectra of X-ray photoelectron spectroscopy analysis showing the changes in surface chemical bonding in the catalyst electrode (PQD@SiO₂/WO₃) and the core-shell structure (PQD@SiO₂), reference electrode (PQD/WO₃), single quantum dot (PQD) according to the example.

FIG. 12e is a diagram showing Cs 3d spectra of X-ray photoelectron spectroscopy analysis showing the changes in surface chemical bonding in the catalyst electrode (PQD@SiO₂/WO₃) and the core-shell structure (PQD@SiO₂) according to the example.

FIG. 12f is a diagram showing Cs 3d spectra of X-ray photoelectron spectroscopy analysis showing the changes in surface chemical bonding in the reference electrode (PQD/WO₃), single quantum dot (PQD) according to the example.

After introducing the quantum dot nanoparticles, it was confirmed that the surface defects of WO₃ could be passivated by introducing the quantum dots, as the W⁵⁺ peak and Ov peak, which are referred to as surface defects of the WO₃ substrate, decreased.

In addition, in the case of the quantum dots, after hybridization with the support, the peaks of all elements constituting the perovskite, such as Cs, Pb, and Br, shifted to higher binding energy, and changed more widely in the core-shell structure.

Therefore, it was confirmed that electron transfer from the perovskite to the WO₃ substrate occurred smoothly despite the presence of SiO₂, which has a large dielectric constant, and stabilized the perovskite crystal.

### Evaluation of Water Electrolysis Reaction

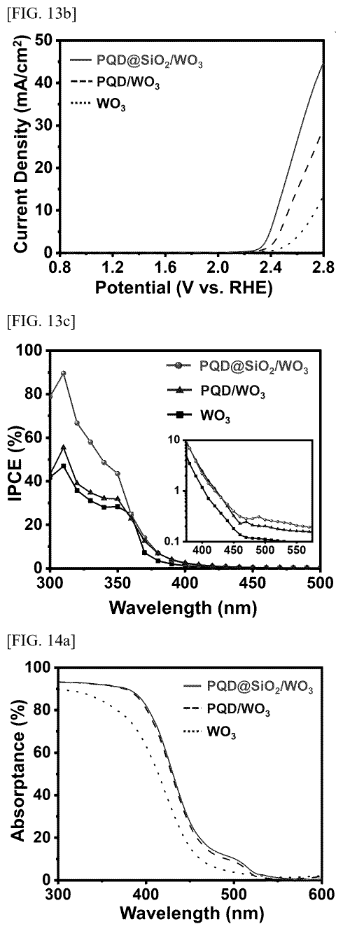

FIG. 13a is a diagram showing the current density under light irradiation conditions of a three-electrode system configured with a catalyst electrode (PQD@SiO₂/WO₃) according to an embodiment, a comparative electrode (PQD/WO₃) according to a comparative example, and an electrode formed only with a support (WO₃) as a working electrode.

FIG. 13b is a diagram showing the current density under dark conditions (in the absence of light irradiation) of a three-electrode system configured with a catalyst electrode (PQD@SiO₂/WO₃) according to an embodiment, a comparative electrode (PQD/WO₃) according to a comparative example, and an electrode formed only with a support (WO₃) as a working electrode.

FIG. 13c is a diagram showing the photon conversion efficiency (IPCE) of a three-electrode system configured with a catalyst electrode (PQD@SiO₂/WO₃) according to an embodiment, a comparative electrode (PQD/WO₃) according to a comparative example, and an electrode formed only with a support (WO₃) as a working electrode.

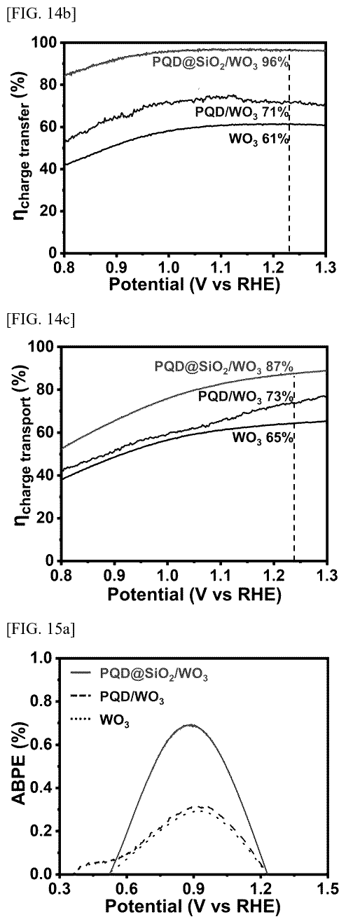

FIG. 14a is a view showing the absorbance of the catalyst electrode according to an embodiment (PQD@SiO₂/WO₃) and a comparative electrode (PQD/WO₃) and a support (WO₃) according to a comparative example.

FIG. 14b is a view showing the charge transfer efficiency of a three-electrode system formed by these as a working electrode according to an embodiment (PQD@SiO₂/WO₃) and a comparative electrode (PQD/WO₃) and a support (WO₃) according to a comparative example.

FIG. 14c is a view showing the charge transport efficiency of a three-electrode system formed by these as a working electrode according to an embodiment (PQD@SiO₂/WO₃) and a comparative electrode (PQD/WO₃) and a support (WO₃) according to a comparative example.

In the solid line of FIG. 13a, the comparative electrode (Comparative Example 2) containing perovskite quantum dots without SiO₂ introduction showed an unstable response current, indicating the instability of perovskite in the aqueous electrolyte.

On the other hand, in the case of the catalyst electrode (Example 2) with the core-shell structure quantum dots introduced, the photocurrent density (3.08 mA/cm²) was improved by about 2.2 times compared to the existing WO₃ (Example 3) substrate (1.38 mA/cm²), and the hybrid photoanode of the quantum dots without SiO₂ introduction showed a photocurrent density improved by about 1.1 times (1.50 mA/cm²).

Therefore, referring to FIG. 13b, it can be confirmed that the surface catalytic properties of the catalyst electrode introduced with the core-shell structure were improved as the onset potential was lowered after the introduction of the quantum dots even under dark conditions (light irradiation blocked).

In addition, through FIG. 13c and FIG. 14a, it can be confirmed that the improved incident photon-to-current efficiency (IPCE) and visible light spectrum around 300-450 nm after the introduction of the core-shell structured perovskite quantum dots improved the light harvesting efficiency after the introduction of the perovskite quantum dots.

The charge transfer efficiency shown in FIG. 14b indicates that the improved surface catalytic properties at the photoanode/electrolyte interface are enhanced after the introduction of quantum dots, as shown in FIG. 13b and FIG. 14c confirms that the charge transport properties from the inside of the electrode containing the core-gum structure nanoparticles to the interface are improved through the charge transport efficiency.

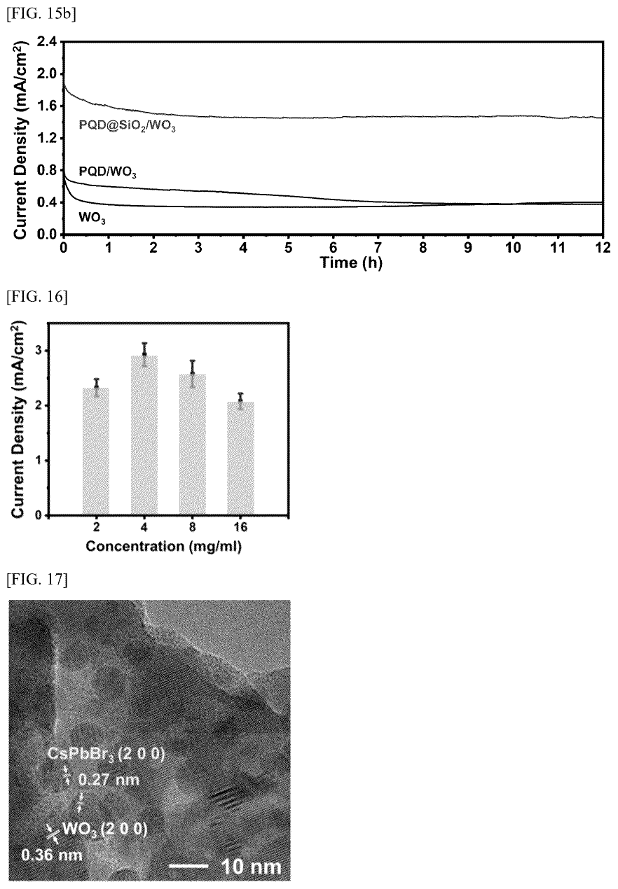

FIG. 15a is a view showing the applied bias photon-to-current efficiency (ABPE) by configuring a three-electrode system with a catalyst electrode (PQD@SiO₂/WO₃) according to an embodiment, a comparative electrode (PQD/WO₃) according to a comparative example, and an electrode formed only with a support (WO₃) as a working electrode.

FIG. 15b is a view showing the change in photocurrent density over time by configuring a three-electrode system with a catalyst electrode (PQD@SiO₂/WO₃) according to an embodiment, a comparative electrode (PQD/WO₃) according to a comparative example, and an electrode formed only with a support (WO₃) as a working electrode.

In FIG. 15a, the applied bias photon-to-current efficiency is shown to show excellent energy conversion efficiency, as shown in FIG. 14c.

And, as a result of the long-term operation stability verification (FIG. 15b), the comparative electrode (Comparative Example 2) with perovskite quantum dots without SiO₂ shell introduction showed a performance degradation to the level of WO₃ substrate after about 8 hours of operation, whereas the catalyst electrode (Example 2) with core-shell structure PQD/SiO₂ quantum dots introduced showed excellent stability for 12 hours along with improved performance.

### Optimization of Spin Coating Solution

FIG. 16 is a diagram showing the change in current density at the oxygen evolution reaction potential (1.23 V vs. RHE) when the same measurement as FIG. 13 was performed according to the concentration of the core-shell structure quantum dot nanoparticle (PQD@SiO₂) to manufacture a catalyst electrode (PQD@SiO₂/WO₃) according to an embodiment.

When the concentration of the perovskite quantum dot (Example 1) solution to be spin-coated on the substrate on which the WO₃ support was formed was adjusted, it was confirmed that the highest current density was shown at 4 mg/ml.

### TEM Analysis of Substrate After Electrolytic Reaction

FIG. 17 shows the results of a transmission electron microscope (TEM) analysis of a catalyst electrode (PQD@SiO₂/WO₃) manufactured according to an embodiment after performing a water electrolysis reaction on a three-electrode system like FIG. 13.

It can be confirmed that perovskite quantum dots (PQD@SiO₂) are stably present on the catalyst electrode even after the reaction is driven.

### Changes in Surface Chemical Bonding After Water Electrolysis Reaction

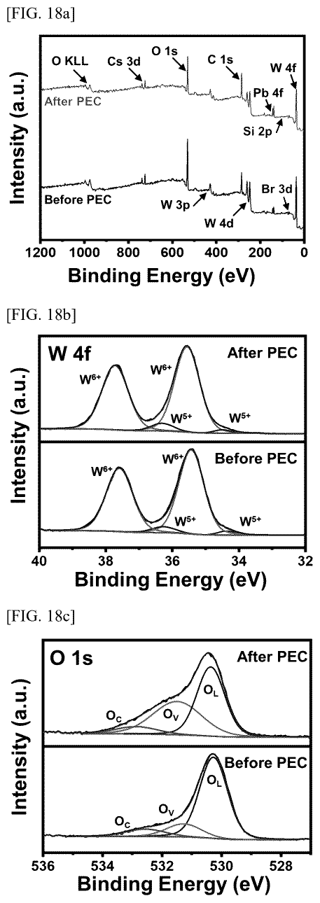

FIG. 18a is a view showing the results of analyzing the surface chemical bonding changes by element using X-ray photoelectron spectroscopy before and after performing a photoelectrochemical water electrolysis reaction on a three-electrode like FIGS. 12a to 12f of a catalyst electrode (PQD@SiO₂/WO₃) manufactured according to an example;

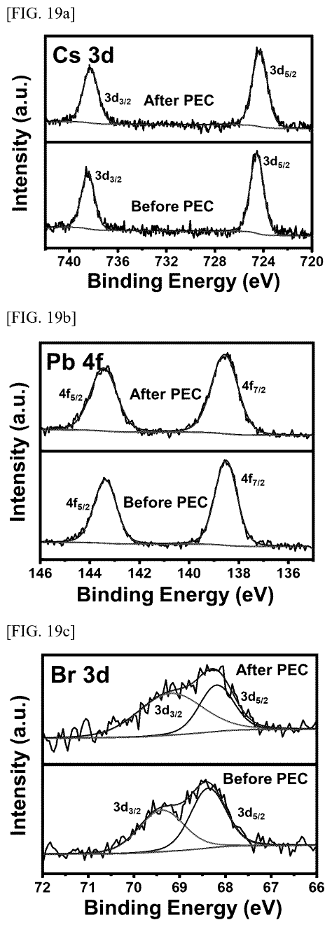

FIGS. 18b to 18c and 19a to 19c is W 4 f, O 1 s, Cs 3 d, Pb 4f and Br 3d X-ray photoelectron spectra showing the surface chemical bonding changes before and after performing a photoelectrochemical water electrolysis reaction on a three-electrode like FIGS. 12a to 12f of a catalyst electrode (PQD@SiO₂/WO₃) manufactured according to an example.

Through this, it was confirmed that each element (total (FIG. 18a), W 4f (FIG. 18b), O 1s (FIG. 18c), Cs 3d (FIG. 19a), Pb 4f (FIG. 19b), Br 3d (FIG. 19c)) constituting the perovskite quantum dot stably exists even after the reaction drive (After PEC).

### Electrochemical Analysis

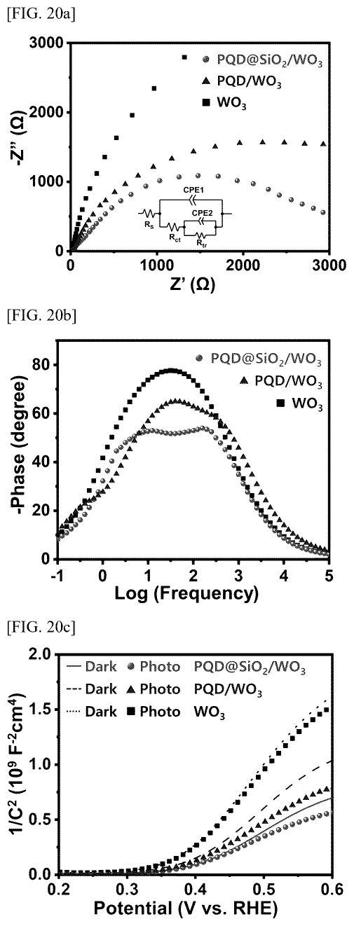

FIG. 20a is a view showing an analysis of charge behavior during photoelectrochemical water electrolysis by using electrochemical impedance spectroscopy (EIS) to configure a three-electrode system using a catalyst electrode (PQD@SiO₂/WO₃) according to an embodiment, a comparative electrode (PQD/WO₃) according to a comparative example, and an electrode formed only with a support (WO₃) as a working electrode.

FIG. 20b is a graph with log frequency on the X-axis and the phase-shift on the Y-axis by using electrochemical impedance spectroscopy (EIS) to configure a three-electrode system using a catalyst electrode (PQD@SiO₂/WO₃) according to an embodiment, a comparative electrode (PQD/WO₃) according to a comparative example, and an electrode formed only with a support (WO₃) as a working electrode.

FIG. 20c is a view showing a Mott-Schottky analysis to configure a three-electrode system using a catalyst electrode (PQD@SiO₂/WO₃) according to an embodiment, a comparative electrode (PQD/WO₃) according to a comparative example, and an electrode formed only with a support (WO₃) as a working electrode.

Compared to the comparative example, the SiO₂ shell was introduced in the embodiment, and the introduced quantum dots showed a small charge transport resistance and charge transfer resistance through a smaller semicircle, indicating that the introduced quantum dots suppressed overall charge recombination within the photoanode and improved surface reaction dynamics.

In addition, in the Bode phase diagram of FIG. 20b, the electron lifetime was 1.27 ms in the core-shell structured quantum dots (Example 2), which was much shorter than the quantum dots without the SiO₂ shell (Comparative Example 2), which were 4.01 ms, and 5.02 ms on the WO₃ substrate, indicating that excellent charge behavior was exhibited despite the presence of SiO₂, which is an insulator.

In the Mott-Schottky diagram of FIG. 20c, it can be confirmed that the semiconductor properties of the catalyst electrode (Example 2) and the comparative electrode (Comparative Example 2) are n-type, like the substrate WO₃, through the positive slope, and it was confirmed that a p-n junction is formed through the heterojunction of the p-type perovskite quantum dots and the n-type WO₃ substrate, and that the built-in electric field is amplified at the heterojunction interface.

Therefore, according to the embodiment, the slope decreases after the introduction of the electrode catalyst having the perovskite quantum dots with the SiO₂ shell formed, which indicates that the charge density on the catalyst surface increases and that charge recombination is suppressed through the increase of the x-intercept.

Additionally, the difference in slope between the dark and light conditions is more pronounced in the case of the electrode catalyst (Comparative Example 2) without the SiO₂ shell compared to Example 2, indicating that the SiO₂ shell significantly suppresses charge recombination that may occur at the heterojunction interface.

### Open Circuit Voltage Analysis

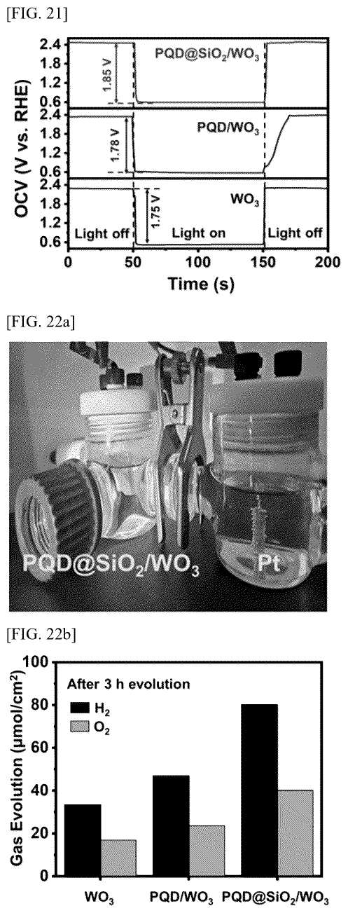

FIG. 21 is a view comparing the open circuit voltage (OCV) when irradiating light by configuring a three-electrode system with a catalyst electrode (PQD@SiO₂/WO₃) according to an embodiment and a comparative electrode (PQD/WO₃) according to a comparative example and an electrode formed only with a support (WO₃) as a working electrode.

In the electrode catalyst having perovskite quantum dots with SiO₂ shells formed according to the embodiment, the difference in OCV before and after light irradiation is large, indicating that the introduction of quantum dots successfully suppresses charge recombination by inducing an amplified internal electromagnetic field effect

On the other hand, in the electrode catalyst having perovskite quantum dots without SiO₂ shells formed according to the comparative example, it can be confirmed that effective electron-hole separation does not occur by showing a slow voltage change after light irradiation is blocked (after 150 seconds).

Therefore, it is shown that unnecessary photocharge recombination can be successfully suppressed when introducing perovskite quantum dots with a core-shell structure.

### Actual System Analysis

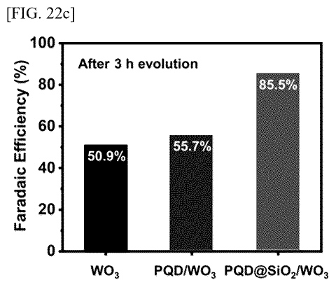

FIG. 22 shows the results of analyzing the actual hydrogen production amount and production efficiency (Faraday efficiency) by configuring a two-electrode water electrolysis system using a catalyst electrode (PQD@SiO₂/WO₃) according to an embodiment, a comparative electrode (PQD/WO₃) according to a comparative example, and an electrode formed only with a support (WO₃) as a working electrode, and using a counter electrode and a proton exchange membrane.

Therefore, it was confirmed that the electrode catalyst (PQD@SiO₂/WO₃) including perovskite quantum dots according to an embodiment exhibited the best photoelectrochemical hydrogen production amount (80.05 μmol/cm²) and production efficiency (85.5%).

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention.

Further, although the operating effects according to the configuration of the present invention are not explicitly described while describing an embodiment of the present invention, it should be appreciated that predictable effects are also to be recognized by the configuration.

### DESCRIPTION OF NUMERAL REFERENCES

1: Core-shell structure (nanoparticle)
10: Core
20: Shell
2: Support
S11: First precursor solution preparation step
S12: First precursor solution dehydration step
S13: Second precursor solution preparation step
S14: Second precursor solution dehydration step
S15: Core manufacturing step
S16: Shell formation step
S17: Catalyst nanoparticle coating step
S18: Structure drying step

1. A core-shell structure comprising:
a core comprising a perovskite nanocrystal; and
a shell surrounding the core.

2. The core-shell structure of claim 1, wherein the perovskite nanocrystal is a core-shell structure including a compound represented by the following chemical formula 1: 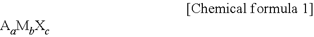
(In the chemical formula 1, A is a monovalent organic or inorganic cation, M is a divalent or trivalent metal cation, and X is a monovalent anion.)

3. The core-shell structure of claim 1, wherein the shell comprises silica (SiO₂).

4. The core-shell structure of claim 3, wherein the shell further comprises an inorganic semiconductor selected from the group consisting of TiOₓ (x is a real number from 1 to 3), indium oxide, tin oxide, zinc oxide, and zinc tin oxide.

5. The core-shell structure of claim 1, wherein the shell is formed with a thickness of 0.5 nm or more and 2 nm or less.

6. An electrode for electrolysis of water comprising a support on which the core-shell structure of claim 1 is supported.

7. The electrode for electrolysis of water of claim 6, wherein the support comprises an inorganic semiconductor selected from a group consisting of tungsten oxide, titanium oxide, indium oxide, tin oxide, and zinc oxide.

8. A method of preparing a core-shell structure comprising:
a first precursor solution preparation step of preparing a first precursor solution by dissolving a first precursor in an organic solvent;
a first precursor solution preparation step of preparing a second precursor solution by dissolving a second precursor in an organic solvent;
a core manufacturing step of preparing a core including perovskite nanocrystals by mixing the first precursor solution with the second precursor solution; and
a shell formation step of forming a shell on the surface of the core by adding a shell precursor to the mixed solution including the core to form a core-shell structured catalyst nanoparticle.

9. The method of preparing the core-shell structure of claim 8, wherein the first precursor comprises at least one selected from cesium carbonate (Cs₂CO₃), methylamidinium iodide (MAI), or formamidinium iodide (FAI).

10. The method of preparing the core-shell structure of claim 8, wherein the second precursor comprises at least one selected from lead iodide (PbI₂), lead bromide (PbBr₂), lead chloride (PbCl₂), tin iodide (SnI₂), tin bromide (SnBr₂), or tin chloride (SnCl₂).

11. The method of preparing the core-shell structure of claim 8, wherein the shell precursor is a silane compound.

12. An electrode for electrolysis of water comprising a support on which the core-shell structure of claim 2 is supported.

13. An electrode for electrolysis of water comprising a support on which the core-shell structure of claim 3 is supported.

14. An electrode for electrolysis of water comprising a support on which the core-shell structure of claim 4 is supported.

15. An electrode for electrolysis of water comprising a support on which the core-shell structure of claim 5 is supported.
